(19) United States
(12) Patent Application Publication
(10) Pub. No.: US 2011/0244770 A1
(43) Pub. Date: Oct. 6, 2011

(54) ABRASIVE SLURRY FORMULATIONS CONTAINING NANO AND MICRO SPHERES ADDITIVES OR SELF-ASSEMBLED MONOLAYERS

(75) Inventor: Zine-Eddine Boutaghou, North Oaks, MN (US)

(73) Assignee: BOUTAGHOU LLC, North Oaks, MN (US)

(21) Appl. No.: 13/079,668

(22) Filed: Apr. 4, 2011

Related U.S. Application Data
(60) Provisional application No. 61/320,787, filed on Apr. 5, 2010.

(51) Int. Cl. B24B 41/00; C09K 3/14

(52) U.S. Cl. 451/540; 51/307; 51/309; 51/298; 51/304

(57) ABSTRACT

This invention relates to methods for plate dressing using slurry charged with abrasives and soft polymeric or metallic micro-nano spheres additives to produce substantially uniform abrasive height. Additionally, methods for plate dressing using slurry charged with abrasives and self-assembled polymers to produce substantially uniform abrasive height are disclosed.

### CROSS-REFERENCE TO RELATED APPLICATIONS

This application claims the benefits of the filing date of U.S. Provisional Patent Application Ser. No. 61/320,787, which is entitled “Lapping slurry formulations containing nanospheres additives” filed Apr. 5, 2010, which is hereby incorporated herein in their entirety by reference.

### BACKGROUND

Lapping is a well-known process of abrasion metal-removal or machining for smoothing or polishing surfaces to a high degree of refinement or accuracy using loose abrasive lapping compound embedded in soft plate referred to as lapping plates. The lapping compound is often in a liquid suspension or semi-liquid form, and is called lapping slurry.

Polishing quality produced on a lapping plate is a strong function of the abrasive height distribution and abrasive density. The tighter the height distribution one can achieve the smoother the finish of the final polishing surfaces. Protruding abrasives from the mean height distribution of the diamonds produce scratches in the polishing surface. An ideal state of a uniform height distribution produces atomically smooth surfaces.

A typical example of magnetic slider bars with trailing edges composed of metallic layers and ceramic layers present very severe challenges during lapping. Composite structures of hard and soft layers present differential lapping rates when lapped using conventional abrasive substrates. The variable polishing rates of the metallic and ceramic materials lead to severe recessions, sensor damage, and other problems.

U.S. Pat. Nos. 7,198,533 and 6,123,612 disclose an abrasive article including a plurality of abrasive particles securely affixed to a substrate with a corrosion resistant matrix material. The matrix material includes a sintered corrosion resistant powder and a brazing alloy. The brazing alloy includes an element which reacts with and forms a chemical bond with the abrasive particles, thereby securely holding the abrasive particles in place. A method of forming the abrasive article includes arranging the abrasive particles in the matrix material, and applying sufficient heat and pressure to the mixture of abrasive particles and matrix material to cause the corrosion resistant powder to sinter, the brazing alloy flows around, react with, and forms chemical bonds with the abrasive particles, and allows the brazing alloy to flow through the interstices of the sintered corrosion resistant powder and forms an inter-metallic compound therewith.

### SUMMARY OF THE INVENTION

The nanospheres can be fabricated hollow. Full nanosphere nano particles have a wide variety industrial and biomedical uses. The manufacturing of uniform and regular nanosphere is becoming a common in an industrial setting. U.S. Pat. No. 6,720,007 B2 addresses the formation of polymeric micro-nano spheres.

The abrasive particles may include diamonds, Aluminum oxides, Titanium oxides, ceria, and the like.

The present invention improves the embedded abrasive height distribution in lapping plates. The height distribution of diamonds improves the surface finish and reduces the number of scratches. When lapping under ideal conditions of a very uniform abrasive height distribution a super smooth surface is attained with no scratches and surface damage.

The invention proposes the addition of flexible polymeric nanospheres as an additive to existing lubricant based abrasive slurries. The sphere diameter distribution and sphere density produce a cushion balancing the applied dressing wheel preload. Manufactured nanospheres are not uniform in diameter or shape distribution (Walt et al., U.S. Pat. No. 6,700,007 B2), a Gaussian distribution can be used to characterize the incoming height distribution. The nanospheres can be coated with non-polar materials to avoid agglomeration as described in Walt et al., U.S. Pat. No. 6,700,007 B2 and Walsh et al., U.S. Pat. No. 6,207,195 B1. The nanospheres can be full sphere or hollow spheres as shown in Walt et al., U.S. Pat. No. 6,700,007 B2 and Walsh et al., U.S. Pat. No. 6,207,195 B1.

The embodiments described herein relate to methods for plate dressing using slurry charged with abrasives and micro-nano sphere additives to produce substantially uniform abrasive height. In particular, soft polymeric nanospherical additives produce a constant spacing between the dressing wheel and the polishing substrate under a given load. Protruding hard abrasives are forced to embed by the dressing wheel in the softer substrate until the resistance of the uniform diameter nan micro-nano sphere balances the applied wheel load. The soft polymeric micro-nano sphere deform under the dressing wheel load to provide a uniform spacing between the lapping plate and the dressing wheel. The slurry contains both abrasives and micro-nano sphere additives. Since the abrasive have a substantially higher hardness, they will embed into the soft lapping substrate while the soft polymeric micro-nano sphere additives deform under the applied load without embedded into the plate and regain their original shape once the load is removed. The micro-nano sphere can be thought of a large number of springs resisting the applied load from the dressing wheel. Upon deforming under the applied load the nanospheres reach an equilibrium state assuring a spacing equal to the mean original height of the nanospheres minus the mean deformation of the nanospheres.

In accordance with one aspect of the present invention, a lapping slurry which includes soft polymer nanospheres dispersed in a carrier fluid charged with abrasive particles.

In accordance with a second aspect of the present invention, a lapping slurry includes abrasive particles and soft polymeric nanospheres dispersed in a carrier fluid. Carrier fluids are often formed from oil, water, glycerine, triethanolamine according to U.S. 2007/0135317 A1.

### BRIEF DESCRIPTION OF THE DRAWINGS

FIG. 1 depicts a diamond charged lapping plate with non uniform protruding diamonds.

FIG. 2 shows the diamond height distribution of the present invention compared to prior art methods.

FIG. 3 shows the dispersion of a slurry charged with abrasives and soft nanospheres on a lapping plate according to an example embodiment of the present invention.

FIG. 4 shows a close up view of the charging process with a dressing wheel at a given applied load of a slurry charged with abrasives and soft nanospheres on a lapping plate according to an example embodiment of the present invention.

FIG. 5 shows a full view of the charging process with a dressing wheel at a given applied load of a slurry charged with abrasives and soft nanospheres on a lapping plate according to an example embodiment of the present invention.

FIG. 6 shows a charged plate where the residual nanospheres have been washed away according to an example embodiment of the present invention.

FIG. 7 shows a lapping plate coated with a uniform thickness film; abrasive slurry is dispersed onto the uniform film thickness according to an example embodiment of the present invention.

FIG. 8 shows a full view of the charging process with a dressing wheel at a given applied load of plate where the applied coating act as a stop layer for the diamond penetration according to an example embodiment of the present invention.

FIG. 9 shows a charged plate where the residual coating has been washed away according to an example embodiment of the present invention.

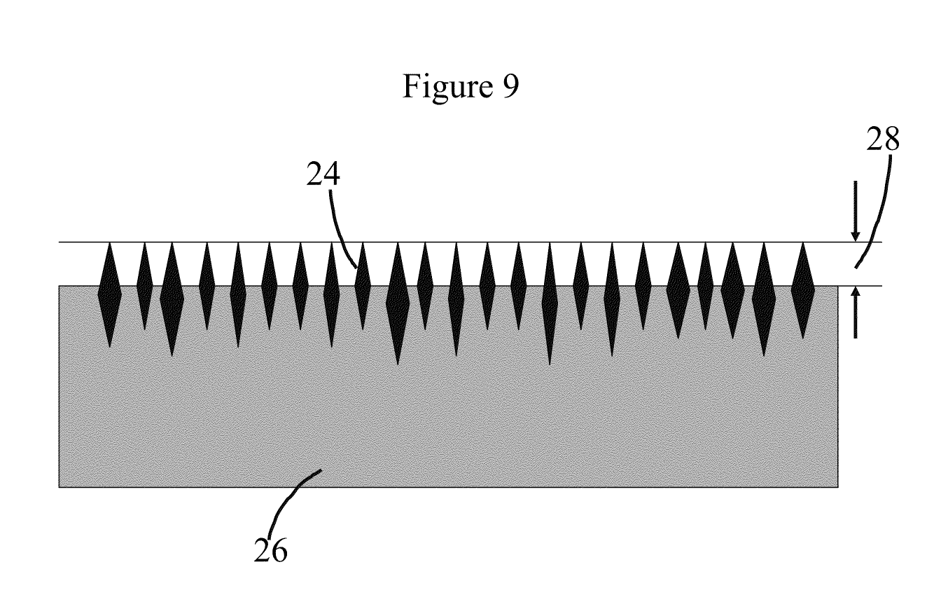

FIG. 10 shows an abrasive article according to an example embodiment of the present invention.

### DETAILED DESCRIPTION OF THE INVENTION

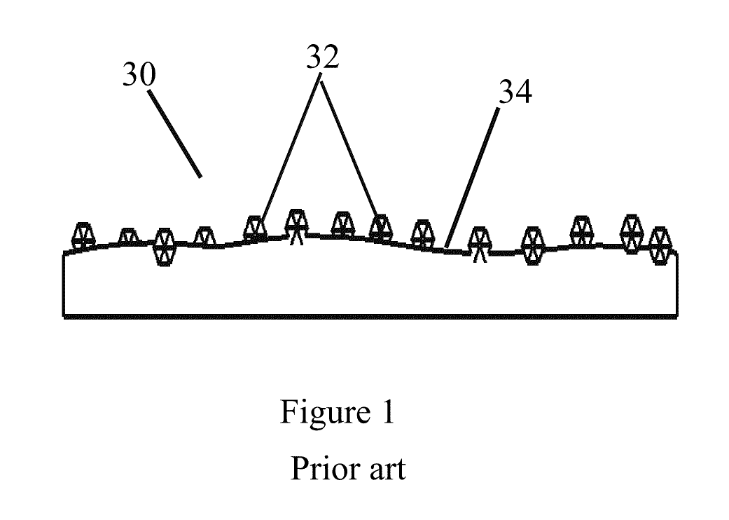

FIG. 1 depicts a prior schematic representation of a charged lapping plate 30 with diamonds 32 on a soft substrate 34. The non uniform height distribution of the diamonds cause a relatively rough finish with scratches experienced by the lapped surface. The high protruding diamonds cause tensile stresses at the surface of ceramic materials. Tensile stresses further cause particle release which is undesirable in many applications.

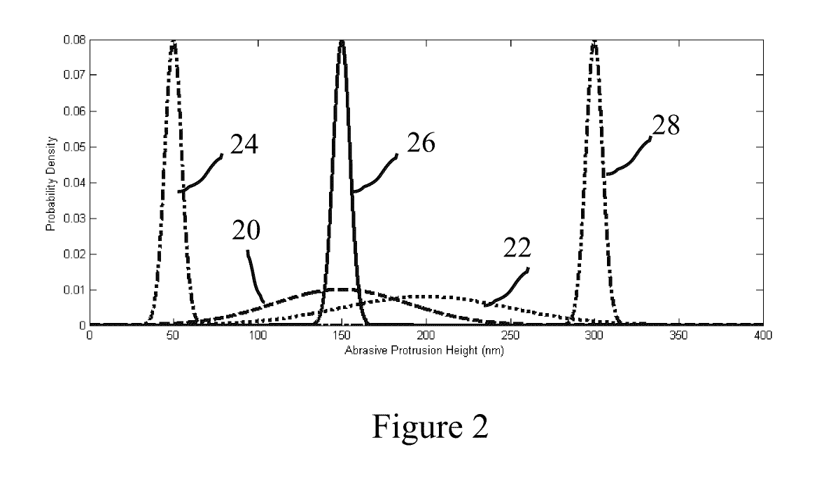

FIG. 2 reflects prior art abrasive height distribution 22 and 20 versus distributions 24, 26, and 28 obtained with the present invention. In prior art applications; large variations are obtained in diamond height distributions as depicted by 22 and 20. Also mean shift from batch to batch charging operations cause mean variations as depicted by 20 and 22. The present invention can precisely dial in a diamond height such as the examples shown in 24, 26, and 28 by precisely controlling the nanospheres diameters into the slurry. For example adding nanospheres with a diameter slightly larger than 150 nm can lead to a mean abrasive height desired of 150 nm with a tight distribution.

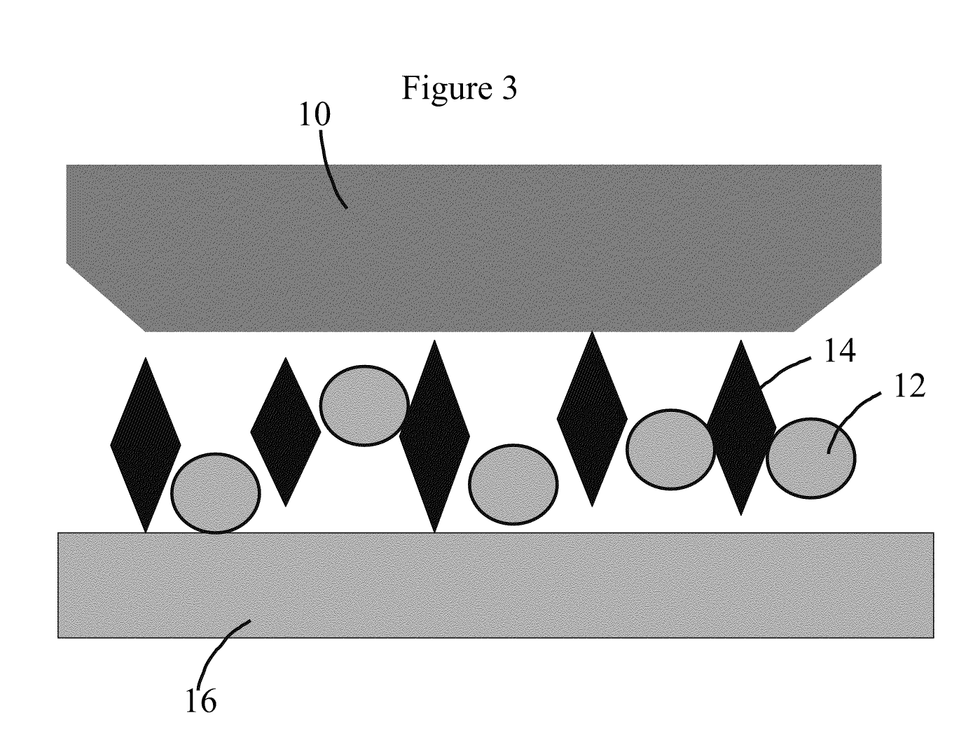

FIG. 3 depicts slurry of abrasive particles 14 and soft nanospheres 12 dispersed in a lubricant (not shown) on a substrate 16. The dressing wheel 10 is shown for illustrative purposes with no load applied.

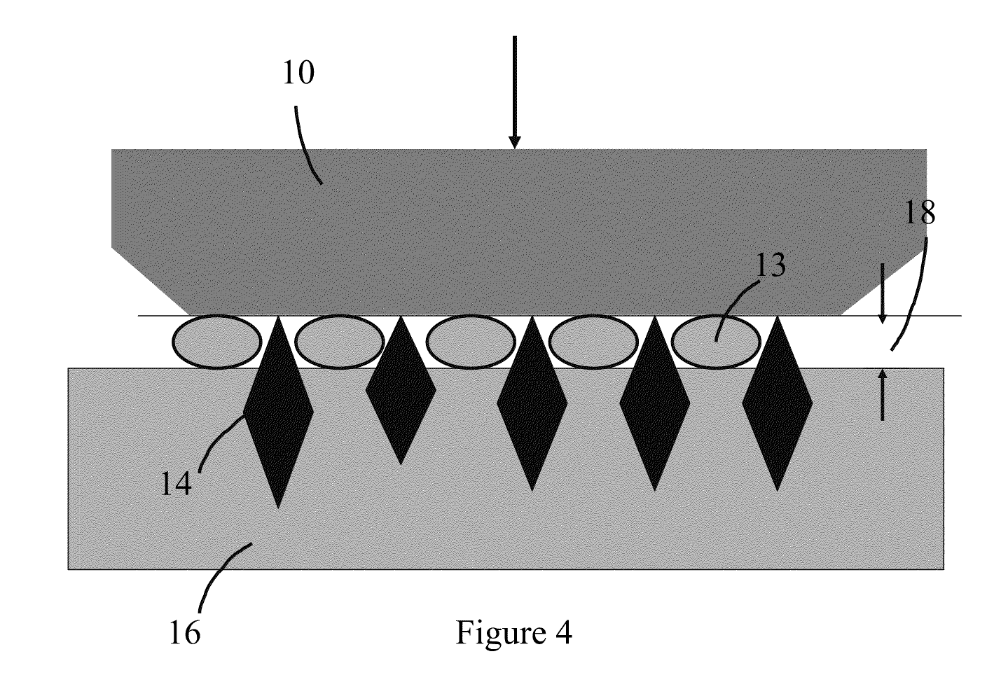

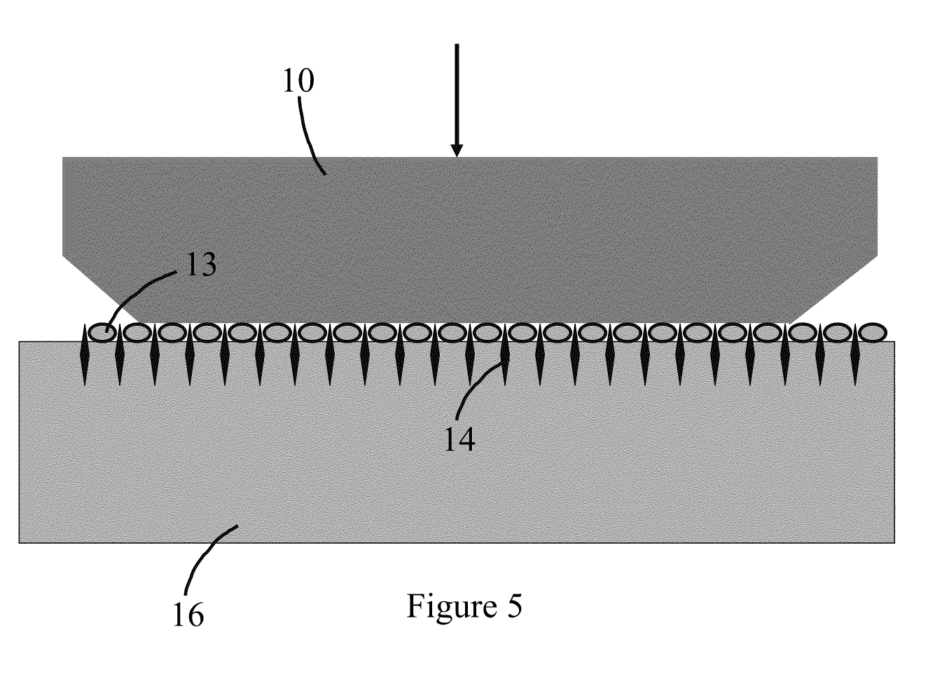

FIGS. 4 and 5 depict slurry of abrasive particles 14 and soft nanospheres 12 dispersed in a lubricant (not shown) on a substrate 16. The dressing wheel 10 applies a preload on the abrasive slurry charged with soft polymeric spheres or nanospheres 13. The soft polymeric nanospheres deform under the dressing wheel preload causing them to take elliptical shapes 13. The final protruding height 18 of the abrasive particles 14 embedded into the soft lapping plate 16 match the spacing formed between the dressing wheel 10 and the lapping plate 16. The nanospheres can be thought of a large number of springs supporting the applied load from the dressing wheel. Upon deforming under the applied load the nanospheres reach an equilibrium state assuring that the spacing between the dressing wheel and the lapping plate equals the final deformed state of the soft polymeric nanospheres.

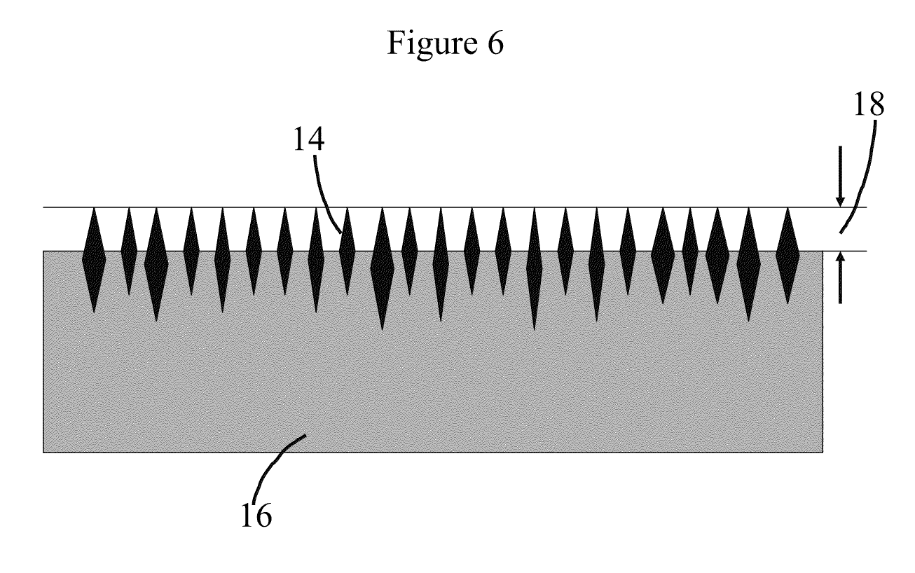

In one example embodiment, the nanosheres are removed, such as by removal of the lubricant and nanoshperes from the substrate 16 after removing the applied load of the dressing wheel 10 (shown in FIG. 5). FIG. 6 depicts a charged lapping plate according to an example embodiment of the present invention. The final abrasive mean height 18 matches the spacing achieved between the dressing wheel 10 (shown in FIG. 5) and the lapping plate or substrate 16. The substrate 16 formed with the abrasive particles is the lapping plate. It should be noted that although a lubricant is the carrier fluid in this example embodiment, other embodiments can use different carrier fluids.

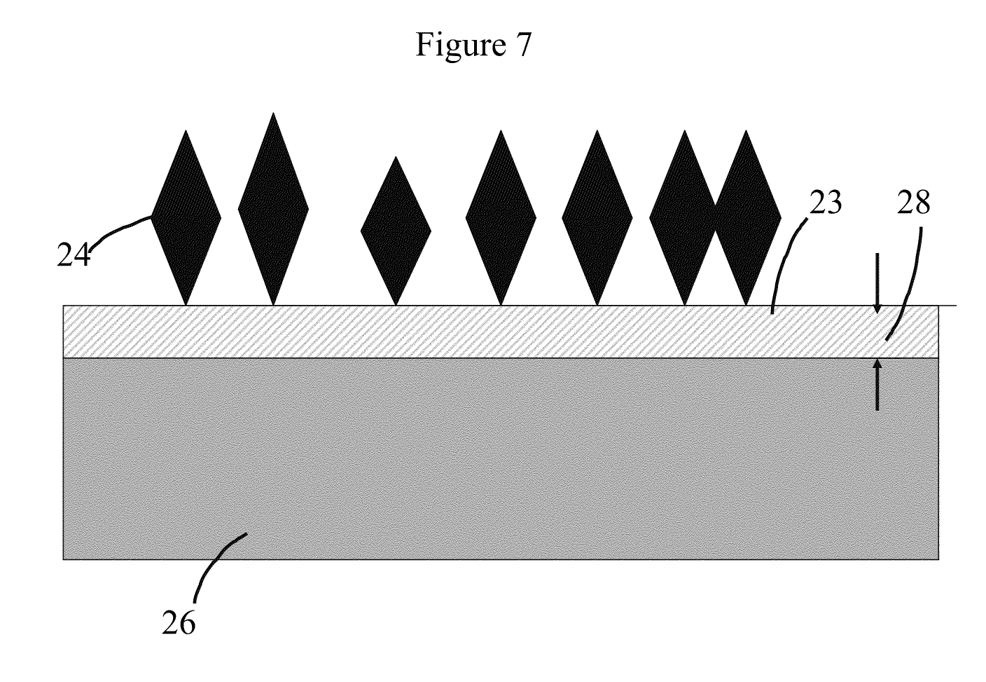

FIG. 7 depicts a lapping plate 26 coated with a uniform thickness film 23 according to another example embodiment of the present invention. The thickness of the coating 23 matches the desired protruding height of the embedded abrasives 28. Abrasive particle slurry 24 is uniformly dispersed above the coating.

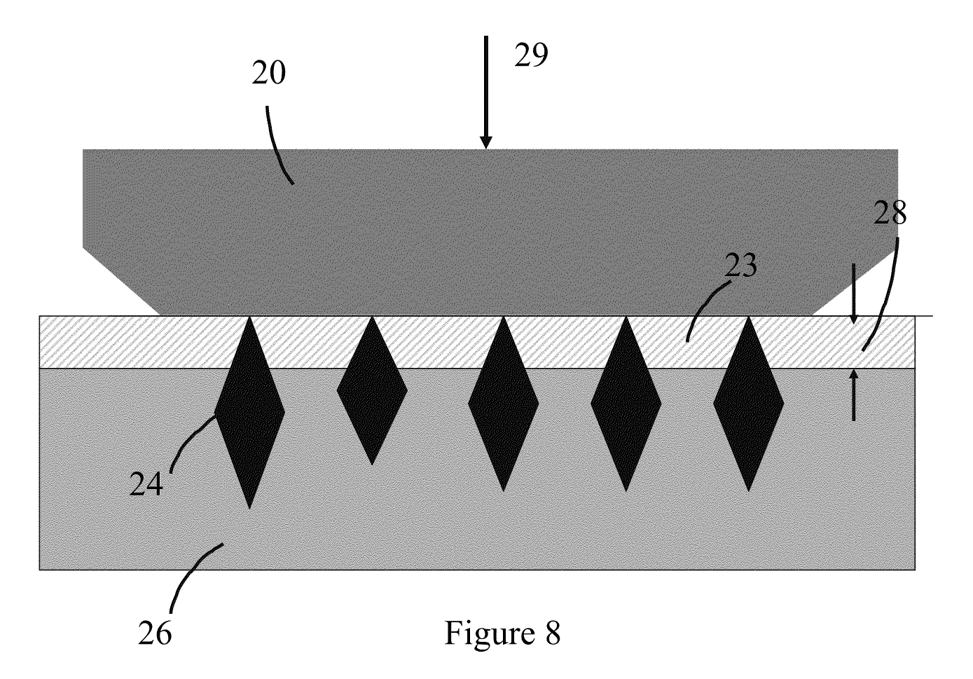

FIG. 8 applies a preload 29 onto a dressing wheel 20 to embed the abrasive particles 24 penetrating the soft coating 23 and the soft lapping plate 26. The soft coating 23 deforms under the applied load 29 to provide resistance. The resistance to the displacement of the dressing wheel can be monitored to provide feedback on the penetration of the abrasive particles into the lapping plate. The coating acts as a uniformly distributed spring system supporting or opposing the applied load 29 from the dressing wheel 20. Upon deforming the coating under the applied load 29 the coating 23 deforms and reaches an equilibrium state assuring that the spacing between the dressing wheel 20 and the lapping plate 26 equals the final deformed state of the soft coating 23. This self limitation process causes the abrasive particles 24 to reach a height substantially uniform equally the initial thickness of the coating 23 minus the coating deformation under the load 29 applied by the dressing wheel 20. Since the abrasive particles 24 are embedded into a soft metal layer such as Tin or Tin Bismuth, the deformation between the abrasive particles 24 and the metal layer is fully plastic presenting zero contact stiffness during an unloading operation. The contact resistance is substantially dominated by the applied coating 23 or the micro-nano spheres.

Soft coatings 23 include self assembled polymers providing a substantially conformal layer throughout the lapping plate. A very thin film of gold is applied to the polishing plate to enhance the adhesion and growth of the self assembled polymer. The self assembled layer can be grown to various precise thickness 28 which is very desirable. Self assembled polymers have good tribological properties of resistance wear and erosion during the abrasive particles embedding process. The abrasive particles easily penetrate the self assembled coating. The self assembled layer can be thought of as an infinite number of springs resisting the dressing wheel applied load to provide a substantially uniform diamond protrusion height.

During the application of the load 29 to embed the abrasive particles, the load will remain constant while the charging wheel 20 experience a displacement equaling the amount of abrasive particles 14, 24 penetration in the soft lapping plate 16, 26. Once the charging wheel contacts the micro-nano spheres or the coating, the reaction due to the deformation of the micro-nano spheres 13 or the coating resists 23 the charging wheel 10, 20 displacement to reach equilibrium between the applied load and the micro-nano spheres or the coating deformations. The contact stiffness attained is directly proportional to the mean height of the protruding abrasive particles. The amount of deformation of the micro-nano spheres or the coating equals the height of protruded abrasive particles.

Multiple layers of soft coatings can be used in combination. For example, a non light sensitive coating can be deposited first, followed by a light sensitive polymer. Desired patterns can be formed and developed onto the light sensitive material. An abrasive slurry is then dispersed.

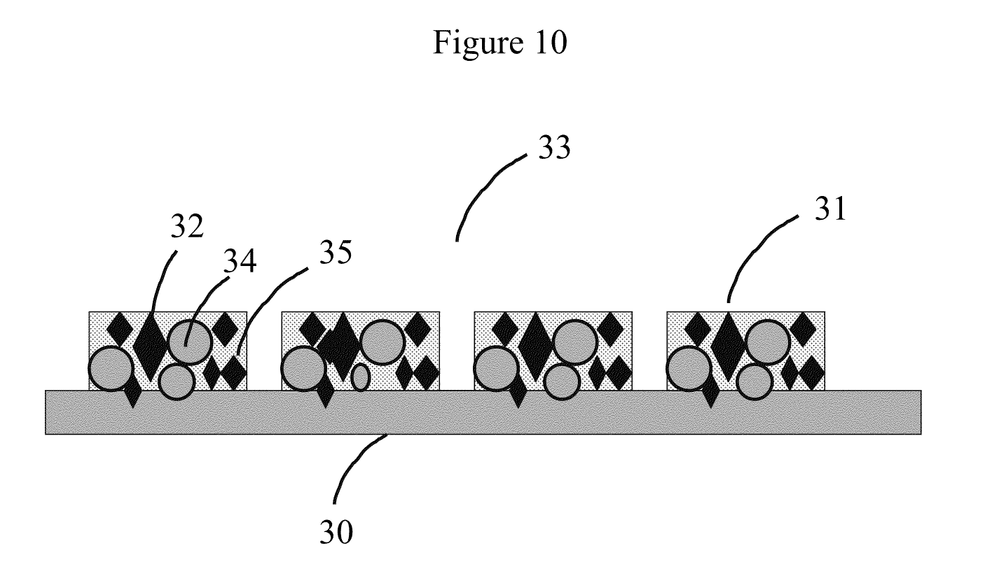

FIG. 10 shows an abrasive article 33 formed with a series of abrasive composite particles 31. Abrasives 32 and micro-nano spheres 34 are dispersed in a binder 35 to form a regularly shaped abrasive composite 31. The abrasive composites 31 are fabricated onto a backing material 30. The binder 35 dissolves in the presence of a lubricant supplied during the polishing of a workpiece. Upon dissolution of the binder, the micro-nano spheres and the abrasives are supplied to the slurry formed by the lubricant, the micro-nano spheres and the abrasives. The micro-nano spheres act as spacers between the workpiece and the abrasive elements. It is desirable that the average diameter of the micro-nano spheres 34 is in the same range of height as the abrasive particles 32.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the example embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. An abrasive polishing slurry comprising:
a carrier fluid;
abrasive particles in the carrier fluid; and
micro-nano spheres in the carrier fluid.

2. The abrasive polishing slurry of claim 1 wherein the micro-nano spheres are spherical shape.

3. The abrasive polishing slurry of claim 1 wherein the micro-nano spheres are elliptical shape.

4. The abrasive polishing slurry of claim 1 wherein the micro-nano spheres the abrasive particles are diamond abrasives.

5. The abrasive polishing slurry of claim 1 wherein the micro-nano spheres are polymeric.

6. The abrasive polishing slurry of claim 5 wherein the micro-nano spheres are hollow.

7. The abrasive polishing slurry of claim 5 wherein the micro-nano spheres are metallic.

8. The abrasive polishing slurry of claim 5 wherein the diameter of the micro-nano spheres of the soft polymeric ranges between 50 nanometers to 100 micrometers.

9. The abrasive polishing slurry of claim 1 wherein the micro-nano spheres are chemically coated.

10. The abrasive polishing slurry of claim 1 wherein the abrasive particles are mechanically dispersed.

11. The abrasive polishing slurry of claim 1 wherein the carrier fluid is oil based.

12. The abrasive polishing slurry of claim 1 wherein the carrier fluid is water based.

13. A method of formulating a lapping slurry that includes abrasive particles in a and micro-nano spheres in a carrier fluid, the method comprising:
combining abrasive particless with liquid ingredients to form a mixture;
adding the micro-nano spheres to the slurry; and
stirring the slurry mixture.

14. A lapping slurry comprising:
a self assembled carrier fluid;
abrasive particles in the self assembled carrier fluid; and
micro-nano spheres in the self assembled carrier fluid.

15. An abrasive article for polishing a surface, the abrasive article comprises:
a backing material; and
abrasive particles, micro-nano spheres and a binder, abrasive particles and micro-nano spheres dispersed in the binder forming an abrasive composite.

16. The abrasive article for polishing a surface wherein abrasive composite of claim 15 is shaped.

17. The abrasive article for polishing a surface of claim 15 wherein the binder is water dissolvable.

18. The abrasive article for polishing a surface of claim 15 wherein the binder is oil dissolvable.
